(19) United States
(12) Patent Application Publication
(10) Pub. No.: US 2013/0317152 A1
(43) Pub. Date: Nov. 28, 2013

(54) POLYMER COMPOSITION CONTAINING DINT AS A SOFTENER

(71) Applicants: Hinnerk Gordon Becker, Essen (DE); Michael Grass, Haltern am See (DE)

(72) Inventors: Hinnerk Gordon Becker, Essen (DE); Michael Grass, Haltern am See (DE)

(73) Assignee: Evonik Oxeno GmbH, Marl (DE)

(21) Appl. No.: 13/989,121

(22) PCT Filed: Oct. 28, 2011
(86) PCT No.: PCT/EP11/69013

§ 371 Date: Aug. 12, 2013

(30) Foreign Application Priority Data
Nov. 24, 2010 (DE) 102010061871.3

(51) Int. Cl. C08K 5/12; C08K 5/10

(52) U.S. Cl. CPC C08K 5/12; C08K 5/10
USPC 524/296

(57) ABSTRACT

The invention relates to a composition comprising at least one polymer selected from the group consisting of polyvinyl chloride, polyvinylidene chloride, polyvinyl butyrate, polyalkyl (meth)acrylate and copolymers thereof, and diisononyl terephthalate (DINT) as plasticizer, where the average degree of branching of the isononyl groups of the ester is in the range from 1.15 to 2.5, and at least one additional plasticizer which reduces processing temperature.

The invention further relates to mouldings produced from the composition and to the use of the composition for floor coverings, wall coverings (e.g. wallpapers), tarpaulins or coated textiles.

The invention relates to a composition comprising at least one polymer selected from the group consisting of polyvinyl chloride, polyvinylidene chloride, polyvinyl butyrate, polyalkyl (meth)acrylate and copolymers thereof, and diisononyl terephthalate (DINT) as plasticizer, and at least one additional plasticizer which reduces processing temperature.

Polyvinyl chloride (PVC) is one of the most important polymers in economic terms, and is used in a wide variety of applications both in the form of rigid PVC and also in the form of flexible PVC. Examples of important application sectors are cable sheathing, floor coverings, wallpapers, and also frames for plastics windows. Plasticizers are added to the PVC in order to increase flexibility. Among these conventional plasticizers are by way of example (ortho)phthalic esters, such as di-2-ethylhexyl phthalate (DEHP), diisononyl phthalate (DINP) and diisodecyl phthalate (DIDP). However, orthophthalic esters are increasingly problematic because of their toxicology. Cyclohexanedicarboxylic esters have therefore recently been described as alternative plasticizers, an example being diisononyl cyclohexanecarboxylate (DINCH).

It is known that as the chain length of the esters increases the incompatibility of the plasticizer with PVC rises. A possible consequence of this is that PVC compositions, e.g. PVC plastisols, exhibit atypical (e.g. unusually high) and unpredictable viscosity curves (e.g. as a function of shear rate), which make it more difficult to process the PVC plastisols. When foils are produced, these often are found to have increasingly non-transparent appearance and/or to exhibit discoloration which by way of example is reflected in an increased yellowness index and which is undesirable in most applications.

An additional factor is that the reduced compatibility of plasticizers and PVC makes the plasticizers less permanent, i.e. makes these migrate relatively rapidly out of the semifinished or finished PVC product, thus severely compromising the functioning and value of the relevant component. The descriptive term “bleed” or “exudation” can be used in some of these instances to describe the behaviour of the plasticizer.

A requirement in the production of PVC plastisols is therefore that minimum viscosity is maintained during processing. High shelf life of the PVC plastisol is moreover desirable. Foils produced from PVC plastisols are intended to be transparent and to have minimum yellowness index. The plasticizer is moreover intended to have high permanence.

There are almost no compositions known hitherto which comply with the abovementioned requirements and while advantageously comprising no orthophthalates.

Alkyl terephthalates are also known in the prior art as other plasticizers for use in PVC. By way of example, EP 1 808 457 A1 describes the use of dialkyl terephthalates characterized in that the alkyl moieties have a longest carbon chain of at least four carbon atoms and have a total number of five carbon atoms per alkyl moiety. It is stated that terephthalic esters having from four to five carbon atoms in the longest carbon chain of the alcohol have good suitability as plasticizers for PVC. It is also stated that this was particularly surprising since these terephthalic esters were previously considered in the prior art to be incompatible with PVC. The publication further states that the dialkyl terephthalates can also be used in chemically or mechanically foamed layers or in compact layers or underlayers.

WO 2009/095126 A1 describes mixtures of diisononyl esters of terephthalic acid, and also processes for producing these. Diisononyl terephthalate mixtures feature a certain average degree of branching of the isononyl moieties which is in the range from 1.0 to 2.2. The compounds are used as plasticizers for PVC. A disadvantage with these long-chain terephthalates, however, is that they are known to have lower compatibility with the polymer matrix in comparison with ortho-phthalates; this results inter alia from the lower polarizability of the plasticizer molecules as a consequence of the higher molecular symmetry.

It is therefore a technical object of the present invention to provide PVC compositions which have good shelf life and which comprise toxicologically non-hazardous plasticizers, where these have low viscosity in the form of plastisols, in order to permit rapid processing at relatively low temperatures, where these give mouldings with good performance characteristics.

The said technical object is achieved via a composition comprising at least one polymer selected from the group consisting of polyvinyl chloride, polyvinylidene chloride, polyvinyl butyrate, polyalkyl (meth)acrylate and copolymers thereof, and diisononyl terephthalate (DINT) as plasticizer, where the average degree of branching of the isononyl groups of the ester is in the range from 1.15 to 2.5, preferably in the range from 1.15 to 2.3, particularly preferably in the range from 1.25 to 2.2, with particular preference in the range from 1.25 to 2 and with very particularly preferred preference in the range from 1.25 to 1.45, and comprising an additional plasticizer which reduces processing temperature.

Surprisingly, it has been found that incompatibility between polymer and plasticizer, leading to the undesired effects described, to the extent that these depend on the processing temperature, arises in particular when gelling, and therefore the formation of a quasi-homogeneous phase, does not occur until high temperatures have been reached, and this is also the case for the terephthalic esters of the invention.

Surprisingly, it has moreover been found that, when a composition comprising a diisononyl terephthalate having the appropriate average degree of branching is used as plasticizer and an additional plasticizer is used which reduces processing temperature, despite relatively low plasticizer efficiency and markedly slower gelling provided by the diisononyl terephthalates when comparison is made with plasticizers of the prior art, foils are obtained which do not differ from the prior art either in terms of transparency or in terms of yellowness index. It was particularly surprising here that firstly a wide variety of additional plasticizers which reduce processing temperature can be used and secondly only small amounts of the said additional plasticizers are needed in order to achieve the desired effect.

In particular, the degree of branching of the terephthalic esters used here is of particular importance for the control or adjustment of plasticizer viscosity, of plastisol viscosity, of processability (in particular in the case of spread-application processes), and also of plasticizer compatibility.

It has moreover been found that a composition comprising a diisononyl terephthalate having the appropriate average degree of branching as plasticizer and comprising an additional plasticizer which reduces processing temperature exhibits markedly improved thermal stability, i.e. a marked delay in discoloration on storage at elevated temperature, than compositions of the prior art.

The method of determining the average degree of branching of the isononyl groups of the diisononyl terephthalate is described below.

¹H NMR methods or ¹³C NMR methods can be used to determine the average degree of branching of the isononyl moieties in the terephthalic diester mixture. According to the present invention, it is preferable to determine the average degree of branching with the aid of ¹H NMR spectroscopy in a solution of the diisononyl esters in deuterochloroform (CDCl₃). The spectra are recorded by dissolving 20 mg of substance in 0.6 ml of CDCl₃ (comprising 1% by weight of TMS) and charging the solution to an NMR tube whose diameter is 5 mm. Both the substance to be studied and the CDCl₃ used can first be dried over a molecular sieve in order to exclude any errors in the values measured due to possible presence of water.

The method of determination of the average degree of branching is advantageous in comparison with other methods for the characterization of alcohol moieties, described by way of example in WO 03/029339, since water contamination in essence has no effect on the results measured and their evaluation. In principle, any commercially available NMR equipment can be used for the NMR-spectroscopic studies. The present NMR-spectroscopic studies used Avance 500 equipment from Bruker. The spectra were recorded at a temperature of 300 K using a delay of d1=5 seconds, 32 scans, a pulse length of 9.7 μs and a sweep width of 10 000 Hz, using a 5 mm BBO (broad band observer) probe head. The resonance signals are recorded in comparison with the chemical shifts of tetramethylsilane (TMS=0 ppm) as internal standard. Comparable results are obtained with other commercially available NMR equipment using the same operating parameters. The resultant ¹H NMR spectra of the mixtures of diisononyl esters of terephthalic acid have, in the range from 0.5 ppm as far as the minimum of the lowest value in the range from 0.9 to 1.1 ppm, resonance signals which in essence are formed by the signals of the hydrogen atoms of the methyl group(s) of the isononyl groups. The signals in the range of chemical shifts from 3.6 to 4.4 ppm can essentially be attributed to the hydrogen atoms of the methylene group adjacent to the oxygen of the alcohol or of the alcohol moiety. The results are quantified by determining the area under the respective resonance signals, i.e. the area included between the signal and the base line.

Commercially available NMR equipment has devices for integrating the signal area. In the present NMR-spectroscopic study, integration used “xwinnmr” software, version 3.5. The integral value of the signals in the range from 0.5 as far as the minimum of the lowest value in the range from 0.9 to 1.1 ppm is then divided by the integral value of the signals in the range from 3.6 to 4.4 ppm to give an intensity ratio which states the ratio of the number of hydrogen atoms present in a methyl group to the number of hydrogen atoms present in a methylene group adjacent to an oxygen atom. Since there are three hydrogen atoms per methyl group and two hydrogen atoms are present in each methylene group adjacent to an oxygen atom, each of the intensities has to be divided by 3 and, respectively, 2 in order to obtain the ratio of the number of methyl groups to the number of methylene groups adjacent to an oxygen atom, in the isononyl moiety. Since a linear primary nonanol which has only one methyl group and one methylene group adjacent to an oxygen atom contains no branching and accordingly must have an average degree of branching of 0, the quantity 1 then has to be subtracted from the ratio. The average degree of branching B can therefore be calculated from the measured intensity ratio in accordance with the following formula:

B=⅔*I(CH₃)/I(OCH₂)−1

B here means degree of branching, I(CH₃) means area integral essentially attributed to the methyl hydrogen atoms, and I(OCH₂) means area integral for the methylene hydrogen atoms adjacent to the oxygen atom.

The composition of the invention comprises at least one polymer selected from the group consisting of polyvinyl chloride, polyvinylidene chloride, polyvinyl butyrate, polyalkyl (meth)acrylate and copolymers thereof. In one preferred embodiment, at least one polymer present in the composition is a polyvinyl chloride. In another preferred embodiment, the polymer is a copolymer of vinyl chloride with one or more monomers selected from the group consisting of vinylidene chloride, vinyl butyrate, methyl (meth)acrylate, ethyl (meth)acrylate and butyl (meth)acrylate.

The amount of diisononyl terephthalate in the composition is preferably from 5 to 120 parts by weight, preferably from 10 to 100 parts by weight, particularly preferably from 15 to 90 parts by weight and very particularly preferably from 20 to 80 parts by weight per 100 parts by weight of polymer.

Plasticizers other than diisononyl terephthalate can optionally be present in the composition.

It is essential that the composition of the invention comprises at least one additional plasticizer which reduces processing temperature. In particular, the processing temperature here is especially characterized within the performance range of the polymer plastisols via the temperature from which, during the gelling process, a significant rise in plastisol viscosity takes place, and also via the temperature from which the maximum plastisol viscosity achievable (for the respective system) is achieved. Plasticizers of the invention are therefore all of those whose addition shifts at least one of the two temperatures to lower temperatures when comparison is made with a similar specimen which comprises only the terephthalic esters of the invention as plasticizer. Particular preference is given here to those additional plasticizers which at the same time have lower intrinsic viscosity than the terephthalic esters of the invention and/or lead to lower plastisol viscosity when comparison is made with a similar specimen which comprises only the terephthalic esters of the invention as plasticizer. These additional plasticizers are by way of example those selected from the following list: dialkyl phthalates, preferably having from 4 to 8 carbon atoms in the alkyl chain; trialkyl trimellitates, preferably having from 4 to 8 carbon atoms in the side chain; dialkyl adipates, preferably having from 4 to 9 carbon atoms; dialkyl terephthalates, preferably respectively having from 4 to 8 carbon atoms, in particular from 4 to 7 carbon atoms in the side chain; alkyl 1,2-cyclohexanedicarboxylates, alkyl 1,3-cyclohexane-dicarboxylates and alkyl 1,4-cyclohexanedicarboxylates, and preferably here alkyl 1,2-cyclohexanedicarboxylates, preferably in each case having from 3 to 8 carbon atoms in the side chain; dibenzoic esters of glycols; alkylsulphonic esters of phenol preferably having an alkyl moiety which comprises from 8 to 22 carbon atoms; glycerol esters, isosorbide esters, citric triesters having a free or carboxylated OH group and, for example, having alkyl moieties of from 4 to 8 carbon atoms, epoxidized oils, in particular epoxidized soya oil and/or epoxidized linseed oil, alkylpyrrolidone derivatives having alkyl moieties of from 4 to 18 carbon atoms, and also alkyl benzoates, preferably having from 7 to 13 carbon atoms in the alkyl chain. In all instances, the alkyl moieties can be linear or branched and identical or different.

It is particularly preferable that the mixtures of the invention use no orthophthalate as additional plasticizer which reduces processing temperature.

In one particular embodiment, at least one of the additional plasticizers used in the composition of the invention and reducing processing temperature is a trialkyl trimellitate. It is preferable that the said trialkyl trimellitate has ester side chains having from 4 to 8 carbon atoms, where the ester groups can either have the same number of carbon atoms or can differ from one another in their number of carbon atoms. At least one of the ester groups present particularly preferably is a group having at most 7 carbon atoms per ester group, and with particular preference is a group having at most 6 carbon atoms and very particularly preferably is a group having at most 5 carbon atoms.

In another particular embodiment, at least one of the additional plasticizers used in the composition of the invention and reducing processing temperature is a dialkyl adipate. It is preferable that the said dialkyl adipate has ester side chains having from 4 to 9 carbon atoms, and here again the ester groups can either have the same number of carbon atoms or can differ from one another in their number of carbon atoms. At least one of the ester groups present particularly preferably is a group having at most 8 carbon atoms per ester group, and with particular preference is a group having at most 7 carbon atoms and very particularly preferably is a group having at most 6 carbon atoms. In particular, at least one of the dialkyl adipates used is dioctyl adipate.

In another particular embodiment, at least one of the additional plasticizers used in the composition of the invention and reducing processing temperature is a dialkyl terephthalate. It is preferable that the said dialkyl terephthalate has ester side chains having from 4 to 9 carbon atoms, and here again the ester groups can either have the same number of carbon atoms or can differ from one another in their number of carbon atoms. At least one of the ester groups present particularly preferably is a group having at most 9 carbon atoms per ester group, and with particular preference is a group having at most 8 carbon atoms and very particularly preferably is a group having at most 7 carbon atoms. In particular, at least one of the dialkyl terephthalates used is di-n-heptyl terephthalate, di-iso-heptyl terephthalate, di-n-butyl terephthalate, di(3-methylbutyl) terephthalate, di(2-methylbutyl) terephthalate or di-n-pentyl terephthalate.

In another particular embodiment, at least one of the additional plasticizers used in the composition of the invention and reducing processing temperature is a dialkyl ester of cyclohexanedicarboxylic acid, particularly preferably a dialkyl ester of 1,2-cyclohexane-dicarboxylic acid. It is preferable that this dialkyl cyclohexanedicarboxylate has ester side chains having from 3 to 8 carbon atoms, and here again the ester groups can either have the same number of carbon atoms or can differ from one another in their number of carbon atoms. At least one of the ester groups present particularly preferably is a group having at most 8 carbon atoms per ester group, and with particular preference is a group having at most 7 carbon atoms and very particularly preferably is a group having at most 6 carbon atoms. In particular, at least one of the dialkyl cyclohexanedicarboxylates used is di-n-pentyl 1,2-cyclohexanedicarboxylate, di-n-heptyl 1,2-cyclohexanedicarboxylate, di-iso-heptyl 1,2-cyclohexanedicarboxylate, di-n-butyl 1,2-cyclohexanedicarboxylate, di-n-butyl 1,4-cyclohexanedicarboxylate, di-n-butyl 1,3-cyclohexanedicarboxylate or di-3-methylbutyl 1,2-cyclohexanedicarboxylate.

In another particular embodiment, at least one of the additional plasticizers used in the composition of the invention and reducing processing temperature is a glycerol ester, particularly preferably a glycerol triester. The ester groups here can be of either aliphatic or aromatic structure, linear and/or branched, and can also comprise, in addition to their ester function, other functional groups, e.g. epoxy and/or hydroxy groups. In the latter case, these are preferably carboxylated groups, in particular acetylated groups. It is preferable that the said glycerol ester has ester side chains having from 1 to 20 carbon atoms, and again here the ester groups can either have the same number of carbon atoms or can differ from one another in their number of carbon atoms. At least one of the ester groups present particularly preferably is a group having at most 15 carbon atoms per ester group, and with particular preference is a group having at most 12 carbon atoms and very particularly preferably is a group having at most 9 carbon atoms. In particular, at least one of the ester groups present is particularly preferably a linear aliphatic ester group having at most 20 carbon atoms, preferably at most 12 carbon atoms, and particularly preferably at most 9 carbon atoms and with particular preference at most 7 carbon atoms. In one particular, preferred embodiment at least one of the ester groups present is an acetyl group (i.e. an acetic ester). In another particular embodiment, at least one of the glycerol esters used is a glycerol triacetate.

In another particular embodiment, at least one of the additional plasticizers used in the composition of the invention and reducing processing temperature is a citric triester having a free or carboxylated OH group. The ester groups here can also be of either aliphatic or aromatic structure. Particular preference is given to a trialkyl citrate having a carboxylated OH group. The said trialkyl citrate preferably has ester side chains having from 1 to 9 carbon atoms, and here again the ester groups can either have the same number of carbon atoms or can differ from one another in their number of carbon atoms. At least one of the ester groups present particularly preferably is a group having at most 9 carbon atoms per ester group, and with particular preference is a group having at most 8 carbon atoms and very particularly preferably is a group having at most 7 carbon atoms. In particular, at least one of the citric esters used is triisobutyl acetylcitrate, tri-n-butyl acetylcitrate, tri-n-pentyl acetylcitrate or tri-iso-heptyl acetylcitrate.

It is preferable that the ratio by mass of additional plasticizers which are used and which reduce processing temperature to diisononyl terephthalate is from 1:20 to 2:1, and particular preference is given here to the ranges from 1:20 to 1:15, from 1:17 to 1:14, from 1:15 to 1:9, from 1:12 to 1:8, from 1:10 to 1:5 and from 1:6 to 1:1.

In principle, the compositions of the invention can by way of example be plastisols. It is further preferable that the composition comprises a suspension PVC, bulk PVC, microsuspension PVC or emulsion PVC. It is particularly preferable that at least one of the PVC polymers present in the composition of the invention is a microsuspension PVC or an emulsion PVC. It is very particularly preferable that the composition of the invention comprises a PVC of which the molecular weight stated as K value (Fikentscher constant) is from 60 to 90 and particularly preferably from 65 to 85.

The composition can moreover preferably comprise additives which in particular have been selected from the group consisting of fillers/reinforcing agents, pigments, matting agents, heat stabilizers, antioxidants, UV stabilizers, costabilizers, solvents, viscosity regulators, deaerating agents, flame retardants, adhesion promoters and processing aids or process aids (e.g. lubricants).

The heat stabilizers neutralize inter alia hydrochloric acid eliminated during and/or after processing of the PVC, and inhibit or delay thermal degradation of the polymer. Any of the usual PVC stabilizers in solid or liquid form can be used as heat stabilizers, for example those based on Ca/Zn, Ba/Zn, Pb, Sn or on organic compounds (OBS), and it is also possible to use acid-binding phyllosilicates, such as hydrotalcite. The mixtures of the invention can in particular have heat stabilizer content of from 0.5 to 10, preferably from 1 to 5, particularly preferably from 1.5 to 4, parts by mass per 100 parts by mass of polymer.

It is equally possible to use what are known as costabilizers with plasticizing effect, in particular epoxidized vegetable oils. It is very particularly preferable to use epoxidized linseed oil or epoxidized soya oil.

The antioxidants are generally substances which specifically suppress the free-radical polymer degradation caused by way of example via high-energy radiation, by, for example, forming stable complexes with the free radicals produced. Particular materials included are sterically hindered amines—known as HALS stabilizers—sterically hindered phenols, phosphites, UV absorbers, e.g. hydroxybenzophenones, hydroxyphenylbenzotriazoles and/or aromatic amines. Suitable antioxidants for use in the compositions of the invention are also described by way of example in “Handbook of Vinyl Formulating” (Editor: R. F. Grossman; J. Wiley & Sons; New Jersey (US) 2008). The content of antioxidants in the mixtures of the invention is advantageously at most 10 parts by mass, preferably at most 8 parts by mass, and particularly preferably at most 6 parts by mass and with particular preference from 0.01 to 5 parts by mass per 100 parts by mass of polymer.

Pigments that can be used for the purposes of the present invention are either inorganic or organic pigments. Examples of inorganic pigments are TiO₂, CdS, CoO/Al₂O₃, Cr₂O₃. Examples of known organic pigments are azo dyes, phthalocyanine pigments, dioxazine pigments, industrial carbon black, and also aniline pigments. It is also possible to use special-effect pigments, e.g. those based on mica or on synthetic substrates. The content of pigments is advantageously at most 10 parts by mass, preferably from 0.01 to 8 parts by mass, particularly preferably from 0.1 to 5 parts by mass per 100 parts by mass of polymer.

Viscosity regulators can bring about either a general lowering of paste/plastisol viscosity (viscosity-lowering reagents and, respectively, additives) or can alter the behaviour of the viscosity (curve) as a function of shear rate. Viscosity-lowering reagents that can be used are aliphatic or aromatic hydrocarbons, and also carboxylic acid derivatives, for example 2,2,4-trimethyl-1,3-pentanediol diisobutyrate, which is known as TXIB (Eastman), or else mixtures of carboxylic esters, wetting agents and dispersing agents of the type known by way of example by product/trade names Byk, Viskobyk and Disperplast (Byk Chemie). Proportions added of viscosity-lowering reagents are advantageously from 0.5 to 50, preferably from 1 to 30, particularly preferably from 2 to 10, parts by mass per 100 parts by mass of polymer.

Fillers that can be used are mineral and/or synthetic and/or natural, organic and/or inorganic materials, e.g. calcium oxide, magnesium oxide, calcium carbonate, barium sulphate, silicon dioxide, phyllosilicate, industrial carbon black, bitumen, wood (e.g. pulverized, in the form of granules or microgranules or fibres, etc.), paper, and natural and/or synthetic fibres. The following are preferably used for the compositions of the invention: calcium carbonates, silicates, talc powder, kaolin, mica, feldspar, wollastonite, sulphates, industrial carbon black and microspheres (in particular glass microspheres). It is particularly preferable that at least one of the fillers used is a calcium carbonate. Frequently used fillers and reinforcing agents for PVC formulations are also described by way of example in “Handbook of Vinyl Formulating” (Editor: R. F. Grossman; J. Wiley & Sons; New Jersey (US) 2008). The amounts of fillers used in the compositions of the invention are advantageously at most 150 parts by mass, preferably at most 120, to particularly preferably at most 100 and with particular preference at most 80 parts by mass per 100 parts by mass of polymer. In one advantageous embodiment, the total proportion of the fillers used in the formulation of the invention is at most 90 parts by mass, preferably at most 80, particularly preferably at most 70 and with particular preference from 1 to 60 parts by mass per 100 parts by mass of polymer.

The invention further provides the use of the composition of the invention for, or for producing, floor coverings, wall coverings (e.g. wallpapers), tarpaulins or coated textiles.

The invention moreover further provides a floor covering comprising the composition of the invention, a wall covering (e.g. a wallpaper) comprising the composition of the invention, a tarpaulin comprising the composition of the invention or a coated textile comprising the composition of the invention.

The diisononyl terephthalates having an average degree of branching of from 1.15 to 2.5 are produced in accordance with the description in WO 2009/095126 A1. This is preferably achieved via using a mixture of isomeric primary nonanols for transesterification of terephthalic esters having alkyl moieties which have less than 8 carbon atoms. As an alternative, it is also possible to use a mixture of primary nonanols having the appropriate abovementioned degrees of branching to produce the diisononyl terephthalate via esterification of terephthalic acid. The production process particularly preferably uses a mixture of isomeric primary nonanols for transesterification of dimethyl terephthalate. Examples of materials marketed for producing the diisononyl terephthalates are particularly suitable nonanol mixtures from Evonik Oxeno which generally have an average degree of branching of from 1.1 to 1.4, in particular from 1.2 to 1.35, and also nonanol mixtures from Exxon Mobil (Exxal 9) which have a degree of branching of up to 2.4. Another possibility is moreover the use of mixtures of nonanols having a low degree of branching, in particular of nonanol mixtures having a degree of branching of at most 1.5, and/or of nonanol mixtures using highly branched nonanols available in the market, e.g. 3,5,5-trimethylhexanol. The latter procedure permits specific adjustment of the average degree of branching within the stated limits.

The nonyl terephthalates used in the invention have the following features with respect to their thermal properties (determined via differential calorimetry/DSC):
1. They have at least one glass transition temperature in the first heating curve (start temperature: −100° C., end temperature: +200° C.; heating rate: 10 K/min.) of the DSC thermogram.
2. At least one of the glass transition temperatures detected in the abovementioned DSC measurement is below a temperature of −70° C., preferably below −72° C., particularly preferably below −75° C. and with particular preference below −77° C. In one advantageous embodiment, in particular when the intention is to use the plastisols to produce mouldings, semifinished products or, respectively, finished products with particularly good low-temperature flexibility, at least one of the glass transition temperatures detected in the abovementioned DSC measurement is below a temperature of −75° C., preferably below −77° C., particularly preferably below −80° C. and with particular preference below −82° C.
3. They have no detectable melting signal (and thus an enthalpy of fusion of 0 J/g) in the first heating curve (start temperature: −100° C., end temperature: +200° C.; heating rate: 10 K/min.) of the DSC thermogram.

The glass transition temperature, and also the enthalpy of fusion, can be adjusted by way of the selection of the alcohol component used for the esterification process, or the alcohol mixture used for the esterification process.

The thermal behaviour described for the terephthalic esters of the invention has a particularly advantageous effect on the properties of the polymer plastisols produced with use of the same, and in particular on the shelf life and processability of the same. The shear viscosity at 20° C. of the terephthalic esters used in the invention is at most 142 mPa*s, preferably at most 140 mPa*s, particularly preferably at most 138 mPa*s and with particular preference at most 136 mPa*s. In one advantageous embodiment, in particular when the intention is to produce plastisols of particularly low viscosity which are suitable by way of example for very fast processing, the shear viscosity at 20° C. of the terephthalic esters used in the invention is at most 120 mPa*s, preferably at most 110 mPa*s, particularly preferably at most 105 mPa*s and with particular preference at is most 100 mPa*s. The shear viscosity of the terephthalic esters of the invention can be specifically adjusted via the use, for the production of the same, of isomeric nonyl alcohols having a particular (average) degree of branching.

The loss in mass of the terephthalic esters used in the invention after 10 minutes at 200° C. is at most 4% by mass, preferably at most 3.5% by mass, particularly preferably at most 3% by mass and with particular preference at most 2.9% by mass. In one advantageous embodiment, in particular when the intention is to produce polymer foams with low emissions, the loss in mass of the terephthalic esters used in the invention after 10 minutes at 200° C. is at most 3% by mass, preferably at most 2.8% by mass, particularly preferably at most 2.6% by mass and with particular preference at most 2.5% by mass. The loss in mass can be specifically influenced and/or adjusted via the selection of the constituents of the formulation, and also in particular via the selection of diisononyl terephthalates having a particular degree of branching.

The (liquid) density of the terephthalic esters used in the invention, determined by means of an oscillating U-tube (for purity of at least 99.7 area % according to GC analysis and a temperature of 20° C.) is at least 0.9685 g/cm³, preferably at least 0.9690 g/cm³, particularly preferably at least 0.9695 g/cm³ and with particular preference at least 0.9700 g/cm³. In one advantageous embodiment, the (liquid) density of the terephthalic esters used in the invention, determined by means of an oscillating U-tube (for purity of at least 99.7 area % according to GC analysis and a temperature of 20° C.), is at least 0.9700 g/cm³, preferably at least 0.9710 g/cm³, particularly preferably at least 0.9720 g/cm³ and with particular preference at least 0.9730 g/cm³. The density of the terephthalic esters of the invention can be specifically adjusted by using, for the production of the same, isomeric nonyl alcohols of particular (average) degree of branching.

The composition of the invention can be produced in various ways. However, the composition is generally produced via intensive mixing of all of the components in a suitable mixing container. The components here are preferably added in succession (see also: “Handbook of Vinyl Formulating” (Editor: R. F. Grossman; J. Wiley & Sons; New Jersey (US) 2008)).

The composition of the invention can be used for producing semifinished products, finished products, mouldings and/or other products. It is particularly preferable that these compositions of the invention comprise at least one polymer selected from the group of polyvinyl chloride, polyvinylidene chloride, and copolymers thereof.

Examples of (final) products that may be mentioned are floors, foils, tarpaulins and coated textiles. In one preferred embodiment, the composition of the invention is used for producing a transparent top coat (transparent outer layer) of a floor covering.

The products made from the composition of the invention are in particular produced by first applying the composition to a substrate or another polymer layer and finally subjecting the composition to thermal processing (i.e. with exposure to thermal energy, e.g. via heating).

Substrates that can be used are materials which remain durably bonded to the resultant moulding, e.g. textile webs or non-woven webs. However, the substrates can also be merely temporary substrates from which the resultant mouldings can in turn be removed. Examples of these substrates can be metal strips or release paper (Duplex paper). It is also possible that a further, optionally already entirely or to some extent (=pregelled) gelled polymer layer functions as substrate. This is in particular the practice in the case of cushion-vinyl floors (CV floors), where these are composed of a plurality of layers.

It is also then optionally possible to proceed to what is known as mechanical embossing, for example by means of an embossing roll, to achieve profiling.

The final thermal processing takes place in what is known as a gelling tunnel, generally an oven, through which the layer made of the composition of the invention applied on the substrate passes, or into which the substrate provided with the layer is briefly introduced. The final thermal processing serves for hardening (gelling) of the applied composition. Typical processing temperatures (gelling temperatures) are in the range from 130 to 280° C., preferably in the range from 150 to 250° C. and with particular preference in the range from 155 to 230° C., and other preferred ranges here are from 150 to 175° C., from 160 to 180° C. and from 180 to 220° C. In a preferred method of gelling, the composition is treated at the abovementioned gelling temperatures for a period of at most 5 minutes, preferably for a period of from 0.5 to 3 minutes. The period of heat treatment here can be adjusted, in the case of continuously operating processes, via the length of the gelling tunnel and the speed at which the substrate comprising the composition passes through the same.

The temperature and time needed for the final thermal processing can in particular also be specifically adjusted by way of the proportion of other plasticizers, in particular those which reduce processing temperature, and also by way of the ratio of terephthalic esters of the invention to the said other plasticizers.

In the case of multilayer systems, the shape of the individual layers is generally first fixed by what is known as pregelling of the applied plastisol at one temperature, and then further layers can be applied. Once all of the layers have been applied, the gelling process is carried out at a higher temperature. This procedure can also be used to transfer the desired profiling to the outer layer. The final layer comprised by the compositions of the invention (e.g. a transparent top coat) can be followed by final coating to seal the surface, for example with use of compositions using isocyanate-containing binders (e.g. polyurethane).

An advantage of the compositions of the invention over the prior art is that the permanence of the mixture used is markedly better than that of diisononyl terephthalate alone. When the gelled polymer film which comprises the compositions of the invention is stored in water (at 30° C.), water absorption within a period of 7 days is less than 10% by mass, preferably less than 8% by mass, particularly preferably less than 6% by mass and with particular preference less than 4% by mass, and loss of mass after 7 days at 30° C. is less than 10% by mass, preferably less than 8% by mass, particularly preferably less than 6% by mass and with particular preference less than 4% by mass. In one preferred embodiment after the gelled polymer film which comprises the compositions of the invention has been stored in water for 7 days at 30° C., water absorption is at most 2% by mass, preferably at most 1.5% by mass, while loss of mass after drying is simultaneously at most 1% by mass, preferably at most 0.5% by mass. As far as any possible bloom or bleed is concerned, no visible migration out of the gelled polymer film which comprises the compositions of the invention can be found after storage at 30° C. for 4 weeks.

Diisononyl terephthalate (DINT) can also be used as plasticizer in compositions of other polymers selected from the group consisting of polyvinyl chloride (PVC), polyvinylidene chloride (PVDC), polyacrylates, in particular polymethyl methacrylate (PMMA), polyalkyl methacrylate (PAMA), fluoropolymers, in particular polyvinylidene fluoride (PVDF), polytetrafluoroethylene (PTFE), polyvinyl acetate (PVAc), polyvinyl alcohol (PVA), polyvinyl acetals, in particular polyvinyl butyral (PVB), polystyrene polymers, in particular polystyrene (PS), expandible polystyrene (EPS), acrylonitrile-styrene-acrylate copolymers (A/S/A), styrene-acrylonitrile copolymers (S/AN), acrylonitrile-butadiene-styrene copolymers and acrylonitrile-butadiene-styrene block copolymers (ABS), styrene-maleic anhydride copolymers (S/MSA), styrene-methacrylic acid copolymers, polyolefins, in particular polyethylene (PE) or polypropylene (PP), thermoplastic polyolefins (TPO), polyethylene-vinyl acetate copolymers (EVA), polycarbonates, polyethylene terephthalate (PET), polybutylene terephthalate (PBT), polyoxymethylene (POM), polyamide (PA), polyethylene glycol (PEG), polyurethane (PU), thermoplastic polyurethane (TPU), polysulphides (PSu), biopolymers, in particular polylactic acid (PLA), polyhydroxybutyric acid (PHB), polyhydroxyvaleric acid (PHV), polyester, starch, cellulose and cellulose derivatives, in particular nitrocellulose (NC), ethylcellulose (EC), cellulose acetate (CA), cellulose acetate/butyrate (CAB), rubber or silicones, and also mixtures or copolymers of the abovementioned polymers or monomeric units thereof. It is preferable that these compositions comprise PVC or homo- or copolymers based on ethylene, on propylene, on butadiene, on vinyl acetate, on glycidyl acrylate, on glycidyl methacrylate, on methacrylates, on acrylates, or on acrylates or methacrylates having, bonded at the oxygen atom of the ester group, alkyl moieties of branched or unbranched alcohols having from 1 to 10 carbon atoms, styrene, acrylonitrile or cyclic olefins.

It is assumed that, even if no further details were given, a person skilled in the art can make very extensive use of the above description. The preferred embodiments and examples are therefore to be interpreted merely as descriptive disclosure and certainly not as disclosure which is in any way limiting. The present invention is explained in more detail below by using examples. Alternative embodiments of the present invention are obtainable in analogous fashion.

Analysis:

1. Determination of Purity

The purity of the esters produced is determined by means of GC, using a “6890N” GC machine from Agilent Technologies and a DB-5 column (length: 20 m, internal diameter: 0.25 mm, film thickness 0.25 μm) from J&W Scientific and a flame ionization detector, under the following conditions:

| | |
|---|---|
| Oven starting temperature: 150° C. | Oven final temperature: 350° C. |
| (1) Heating rate from 150 to 300° C.: | (2) Isothermal: 10 min. at |
| 10 K/min | 300° C. |
| (3) Heating rate from 300 to 350° C.: | |
| 25 K/min. | |
| Total running time: 27 min. | |
| Ingoing temperature of injection | Split ratio: 200:1 |
| block: 300° C. | |
| Split flow rate: 121.1 ml/min | Total flow rate: 124.6 ml/min. |
| Carrier gas: Helium | Injection volume: 3 microlitres |
| Detector temperature: 350° C. | Combustion gas: Hydrogen |
| Hydrogen flow rate: 40 ml/min. | Air flow rate: 440 ml/min. |
| Makeup gas: Helium | Flow rate of makeup gas: |
| | 45 ml/min. |

The gas chromatograms obtained are evaluated manually against available comparative substances (di(isononyl) orthophthalate/DINP, di(isononyl) terephthalate/DINT), and purity is stated in area per cent. Because the final contents of target substance are high at >99.7%, the probable error due to lack of calibration for the respective sample substance is small.

2. Determination of Degree of Branching

The degree of branching of the esters produced is determined by means of NMR spectroscopy, using the method described in detail above.

3. Determination of APHA Colour Index

The colour index of the esters produced was determined to DIN EN ISO 6271-2.

4. Determination of Density

The density of the esters produced was determined at 20° C. by means of an oscillating U-tube to DIN 51757—Method 4.

5. Determination of Acid Number

The acid number of the esters produced was determined to DIN EN ISO 2114.

6. Determination of Water Content

The water content of the esters produced was determined to DIN 51777 Part 1 (Direct Method).

7. Determination of Intrinsic Viscosity

The intrinsic viscosity (shear viscosity) of the esters produced was determined by using a Physica MCR 101 (Anton-Paar) with Z3 measurement system (DIN 25 mm) in rotation mode by the following method:

Ester and measurement system were first controlled to a temperature of 20° C., and then the following procedures were activated by the “Rheoplus” software:

1. Preshear at 100 s⁻¹ for a period of 60 s with no measured values recorded (in order to achieve stabilization with respect to any thixotropic effects that may arise and to improve temperature distribution).

2. A decreasing shear rate profile, starting at 500 s⁻¹ and ending at 10 s⁻¹, divided into a logarithmic series with 20 steps each with measurement point duration of 5 s (verification of Newtonian behaviour).

All of the esters exhibited Newtonian flow behaviour. The viscosity values have been stated by way of example at a shear rate of 42 s⁻¹.

8. Determination of Loss of Mass at Elevated Temperature

Loss of mass at 200° C. from the esters produced was determined with the aid of a Mettler halogen drier (HB43S). Measurement parameters set were as follows:

Temperature profile: Constant 200° C.

Measured value recording: 30 s

Measurement time: 10 min

Amount of specimen: 5 g

The measurement process used disposable aluminium dishes (Mettler) and an HS 1 fibre filter (glass non-woven from Mettler). After stabilization and taring of the balance, the specimens (5 g) were uniformly distributed on the fibre filter with the aid of a disposable pipette, and the measurement process was started. Two determinations were carried out for each specimen and the measured values were averaged. The final measured value after 10 min is stated as “Loss of mass after 10 minutes at 200° C.”.

9. DSC analysis method, determination of enthalpy of fusion

Enthalpy of fusion and glass transition temperature were determined by differential calorimetry (DSC) to DIN 51007 (temperature range from −100° C. to +200° C.) from the first heating curve at a heating rate of 10 K/min. Before the measurement process, the specimens were cooled to −100° C. in the measurement equipment used, and then heated at the heating rate stated. The measurement was carried out under nitrogen as inert gas. The inflection point of the heat flux curve is taken as the glass transition temperature. Enthalpy of fusion is determined via integration of the peak area(s), by using software in the equipment.

10. Determination of Plastisol Viscosity

The viscosity of the PVC plastisols was measured using a Physica MCR 101 (Anton-Paar) with “Z3” measurement system (DIN 25 mm) in rotation mode by the following method.

The plastisol was first homogenized manually with a spatula in the mixing container and then charged to the measurement system and measured isothermally at 25° C. The procedures activated during the measurement were as follows:

1. Preshear at 100 s⁻¹ for a period of 60 s with no measured values recorded (in order to achieve stabilization with respect to any thixotropic effects that may arise).

2. A decreasing shear rate profile, starting at 200 s⁻¹ and ending at 0.1 s⁻¹, divided into a logarithmic series with 30 steps each with measurement point duration of 5 seconds.

The measurements were generally (unless otherwise stated) carried out after 24 h of storage/ageing of the plastisols. The plastisols were stored at 25° C. prior to the measurements.

11. Determination of Gelling Rate

The gelling behaviour of the plastisols was studied in a Physica MCR 101 in oscillation mode using a plate-on-plate measurement system (PP25), operated with shear-stress control. An additional temperature-control hood was attached to the equipment in order to optimize heat distribution.

Measurement Parameters:
Mode: Temperature gradient (temperature profile)
Starting temperature: 25° C.
Final temperature: 180° C.
Heating/cooling rate: 5 K/min
Oscillation frequency: from 4 to 0.1 Hz profile (logarithmic)
Angular frequency Omega: 10 1/s
Number of measurement points: 63
Measurement point duration: 0.5 min
No automatic gap adjustment
Constant measurement point duration
Gap width 0.5 mm

Measurement Method:

A spatula was used to apply a drop of the plastisol formulation to be tested, free from air bubbles, to the lower plate of the measurement system. Care was taken here to ensure that some plastisol could exude uniformly out of the measurement system (not more than about 6 mm overall) after the measurement system had been closed. The temperature-control hood was then positioned over the specimen and the measurement was started. The “complex viscosity” of the plastisol was determined as a function of temperature. The onset of the gelling process was discernible via a sudden marked rise in complex viscosity. The earlier the onset of this viscosity rise, the lower the processing temperature that can be selected for the system Interpolation was used on the resultant measured curves to determine, for each plastisol, the temperature at which a complex viscosity of 1000 Pa·s or, respectively, 10 000 Pa*s had been reached. In addition, a tangent method was used to determine the maximum plastisol viscosity reached in this experimental system, and the temperature from which maximum plastisol viscosity occurs was determined by dropping a perpendicular.

12. Determination of Yellowness Index on Foils

Yellowness index (YD 1925 index) is a measure of yellow discoloration of a test specimen. “Spectro Guide” equipment from Byk-Gardner was used for colour measurement. A white reference tile was used as background for the colour measurements. Parameters set were as follows:

Illuminant: C/2°

Number of measurements: 3

Display: CIE L*a*b*

Index measured: YD1925

The actual measurements were carried out at 3 different positions on the specimens (using a plastisol doctor thickness of 200 μm for special-effect foams and smooth foams). The values from the 3 measurements were averaged.

13. Determination of Shore Hardness (Plasticizer Efficiency)

The hardness measurements were carried out to DIN 53 505, using Shore A measurement equipment and Shore D measurement equipment from Zwick-Roell, and in each case the measured value was read after 3 seconds. Measurements were carried out at 3 different positions on each test specimen (e.g. casting), and an average value was calculated.

14. Determination of Opacity of Top Coat Foils

“Spectro Guide” equipment from Byk-Gardner was used to determine opacity. A white tile and a black tile were used as background for the opacity measurements. Opacity measurement was selected by way of the menu on the colour measurement equipment. The actual measurements were carried out at 3 different positions on the specimens and were evaluated automatically.

15. Determination of Water Absorption and Loss of Mass Via Storage in Water at 30° C.

Water absorption and leaching behaviour (=loss of mass due to storage in water) are two essential criteria for assessing the quality of plastics floor coverings and also of coated textiles, e.g. tarpaulins. If a plastics floor absorbs relatively large amounts of water, this results in alteration firstly of the properties of the material and secondly also of its appearance (an example being haze). High water absorption is therefore generally undesirable. Leaching behaviour is an additional criterion for the permanence of the w formulation constituents under service conditions. This applies in particular to stabilizers, and to plasticizers and/or constituents thereof, since a reduction in the concentration of the said formulation constituents within the plastics floor can drastically impair not only the properties of the material but also lifetime of the floor covering. The test specimens used comprised gelled polymer films (200° C., 2 min.) from which circles of suitable size (diameter for example 3 cm) had been cut out. Prior to storage in water, the circles were stored at 25° C. for 24 hours in a desiccator equipped with desiccant (KC-Trockenperlen, BASF SE). The initial weight (ingoing weight) was determined to accuracy of 0.1 mg with an analysis balance. The circles were then stored in a water bath equipped with shaker system and filled with deionized water (“WNB 22” with “CDP” Peltier cooling apparatus; Memmert GmbH) for 7 days at a temperature of 30° C., using suitable specimen holders under the surface of the water, and were kept in continuous motion. After the storage process, the circles were removed from the water bath, dried and weighed (=weight after 7 days). Water absorption was calculated by taking the difference from the ingoing weight. After outgoing weight had been determined, the circles were again stored at 25° C. for 24 hours in a desiccator equipped with a desiccant (KC-Trockenperlen) and another outgoing weight was then recorded (final outgoing weight=weight after drying). The loss of mass due to storage in water was calculated by taking the difference from the ingoing weight.

### EXAMPLE 1

Production of the Terephthalic Esters

1.1 Production of Diisononyl Terephthalate (DINT) from Terephthalic Acid and Isononanol from Evonik Oxeno GmbH (in the Invention)

644 g of terephthalic acid (Sigma Aldrich Co.), 1.59 g of tetrabutyl orthotitanate (Vertec TNBT, Johnson Matthey Catalysts) and 1440 g of an isononanol (Evonik OXENO GmbH) produced by way of the OCTOL process were used as initial charge in a 4 litre stirred flask with water separator and superposed high-performance condenser, stirrer, immersed tube, dropping funnel and thermometer, and the mixture was esterified as far as 240° C. After 8.5 hours, the reaction had ended. The excess alcohol was then removed by distillation as far as 190° C. and <1 mbar. The mixture was then cooled to 80° C. and neutralized using 8 ml of a 10% strength by mass aqueous NaOH solution. Steam distillation was then carried out at a temperature of 180° C. and at a pressure of from 20 to 5 mbar. The mixture was then cooled to 130° C. and dried at 5 mbar at this temperature. After cooling to <100° C., the mixture was filtered through filter aid (perlite). The resultant ester content (purity) according to GC was 99.9%.

1.2 Production of Diisononyl Terephthalate (DINT) from Dimethyl Terephthalate (DMT) and Isononanol from Evonik Oxeno GmbH (in the Invention)

776 g of dimethyl terephthalate/DMT (Oxxynova), 1.16 g of tetrabutyl orthotitanate (Vertec TNBT, Johnson Matthey Catalysts) and initially 576 g of the total of 1440 g of isononanol (Evonik OXENO GmbH) were used as initial charge in a 4 litre stirred flask with distillation bridge with reflux divider, 20 cm Multifill column, stirrer, immersed tube, dropping funnel and thermometer. The mixture was slowly heated, with stirring, until no residual solid was visible. Heating was continued until the reflux divider produced methanol. The reflux divider was adjusted in such a way as to keep the overhead temperature constant at about 65° C. Starting at a bottom temperature of about 240° C., the remaining alcohol was added slowly in such a way as to keep the temperature in the flask constant and maintain adequate reflux. From time to time, a specimen was studied by means of GC, and diisononyl terephthalate content and methyl isononyl terephthalate content were determined. The transesterification process was terminated when methyl isononyl terephthalate content was <0.2 area % (GC). The work-up was analogous to the work-up described in Example 1.1.

1.3 Production of Diisononyl Terephthalate (DINT) from Terephthalic Acid and Isononanol from ExxonMobil (in the Invention)

830 g of terephthalic acid (Sigma Aldrich Co.), 2.08 g of tetrabutyl orthotitanate (Vertec TNBT, Johnson Matthey Catalysts) and 1728 g of an isononanol (Exxal 9, ExxonMobil Chemicals) produced by way of the polygas process were used as initial charge in a 4 litre stirred flask with water separator and superposed high-performance condenser, stirrer, immersed tube, dropping funnel and thermometer, and the mixture was esterified at 245° C. After 10.5 hours, the reaction had ended. The excess alcohol was then removed by distillation at 180° C. and 3 mbar. The mixture was then cooled to 80° C. and neutralized using 12 ml of a 10% strength by mass aqueous NaOH solution. Steam distillation was then carried out at a temperature of 180° C. and at a pressure of from 20 to 5 mbar. The mixture was then dried at 5 mbar at this temperature and, after cooling to <100° C., filtered. The resultant ester content (purity) according to GC was 99.9%.

1.4 Production of Diisononyl Terephthalate (DINT) from Terephthalic Acid and N-nonanol (Comparative Example)

By analogy with Example 1.1, n-nonanol (Sigma Aldrich Co.), instead of the isononanol, was esterified with terephthalic acid and worked up as described above. The product, which according to GC had >99.8% ester content (purity), solidified on cooling to room temperature.

1.5 Production of Diisononyl Terephthalate (DINT) from Terephthalic Acid and 3,5,5-Trimethylhexanol (Comparative Example)

By analogy with Example 1.1, 3,5,5-trimethylhexanol (OXEA GmbH), instead of the isononanol, was esterified with terephthalic acid and worked up as described above. The product, which according to GC had >99.5% ester content (purity), solidified on cooling to room temperature.

1.6 Production of Diisononyl Terephthalate (DINT) from Terephthalic Acid, Isononanol and 3,5,5-Trimethylhexanol (Comparative Example)

166 g of terephthalic acid (Sigma Aldrich Co.), 0.10 g of tetrabutyl orthotitanate (Vertec TNBT, Johnson Matthey Catalysts) and an alcohol mixture made of 207 g of an isononanol (Exxal 9, ExxonMobil Chemicals) produced by way of the polygas process and 277 g of 3,5,5-trimethylhexanol (OXEA GmbH) were used as initial charge in a 2 litre stirred flask with water separator, high-performance condenser, stirrer, immersed tube, dropping funnel and thermometer, and were esterified as far as 240° C. After 10.5 hours, the reaction had ended. The stirred flask was then attached to a Claisen bridge with vacuum divider, and the excess alcohol was removed by distillation as far as 190° C. and <1 mbar. The mixture was then cooled to 80° C. and neutralized using 1 ml of a 10% strength by mass aqueous NaOH solution. The mixture was then purified via passage of nitrogen (“stripping”) at a temperature of 190° C. and a pressure of <1 mbar. The mixture was then cooled to 130° C., and dried at <1 mbar at this temperature and, after cooling to 100° C., filtered. The resultant ester content (purity) was 99.98% according to GC.

1.7 Production of Diisononyl Terephthalate (DINT) from Terephthalic Acid, Isononanol and 3,5,5-Trimethylhexanol (in the Invention)

166 g of terephthalic acid (Sigma Aldrich Co.), 0.10 g of tetrabutyl orthotitanate (Vertec TNBT, Johnson Matthey Catalysts) and an alcohol mixture made of 83 g of an isononanol (Exxal 9, ExxonMobil Chemicals) produced by way of the polygas process and 153 g of 3,5,5-trimethylhexanol (OXEA GmbH) were used as initial charge in a 2 litre stirred flask with water separator, high-performance condenser, stirrer, immersed tube, dropping funnel and thermometer, and were esterified as far as 240° C. After 10.5 hours, the reaction had ended. The stirred flask was then attached to a Claisen bridge with vacuum divider, and the excess alcohol was removed by distillation as far as 190° C. and <1 mbar. The mixture was then cooled to 80° C. and neutralized using 1 ml of a 10% strength by mass aqueous NaOH solution. The mixture was then purified via passage of nitrogen (“stripping”) at a temperature of 190° C. and a pressure of <1 mbar. The mixture was then cooled to 130° C., and dried at <1 mbar at this temperature and, after cooling to 100° C., filtered. The resultant ester content (purity) was 99.98% according to GC.

Characteristic parameters of materials for the esters obtained in 1 have been collated in Table 1.

TABLE 1
Parameters of materials of the terephthalic esters produced in Example 1
(examples of the invention and comparative examples)

| | | | | | | | | Loss of mass | | |
|---|---|---|---|---|---|---|---|---|---|---|
| | | Degree of | | | Acid | | | after 10 | | |
| | | branching | APHA | | number | Water | Intrinsic | minutes | DSC | |
| Product | Purity (GC) | (NMR) | colour | Density | [mg | content | viscosity | @200° C. | T_{g} | ΔH_{M} |
| (according to example) | [Area %] | [-] | [-] | [g/cm³] | KOH/g] | [%] | [mPa*s] | [% by mass] | [° C.] | [J/g] |
| Di(n-nonyl) | 99.75 | 0 | n.d. | n.d. | 0.013 | 0.035 | n.d. | 1.2 | none | 158.2 |
| terephthalate | | | | (solid) | | | (solid) | | | |
| (Example 1.4/ | | | | | | | | | | |
| Comparative Example) | | | | | | | | | | |
| Di(nonyl) terephthalate | 99.97 | 1.32 | 2 | 0.9743 | 0.01 | 0.007 | 96 | 2.2 | −86 | 0 |
| (Example 1.1/in the | | | | | | | | | | |
| invention) | | | | | | | | | | |
| Di(nonyl) terephthalate | 99.8 | 2.13 | 29 | 0.9724 | 0.001 | 0.003 | 136 | 2.2 | −78 | 0 |
| (Example 1.3/in the | | | | | | | | | | |
| invention) | | | | | | | | | | |
| Di(3,5,5-trimethylhexyl) | 99.76 | 2.99 | n.d. | n.d. | 0.016 | 0.01 | n.d. | 2.7 | none | 107.4 |
| terephthalate (Example | | | | (solid) | | | (solid) | | | |
| 1.5/Comparative | | | | | | | | | | |
| Example) | | | | | | | | | | |
| Di(nonyl) terephthalate | 99.98 | 2.49 | 14 | 0.9704 | 0.013 | 0.019 | 140 | 2.5 | −73 | 0 |
| (Example 1.7/in the | | | | | | | | | | |
| invention) | | | | | | | | | | |
| Di(nonyl) terephthalate | 99.98 | 2.78 | 90 | 0.9681 | 0.03 | 0.011 | 145 | 2.6 | −69 | 44.6 |
| (Example 1.6/ | | | | | | | | | | |
| Comparative Example) | | | | | | | | | | |
| Di(isononyl) phthalate, | 99.95 | 1.3 | 5 | 0.9741 | 0.016 | 0.023 | 76 | 3.7 | −86 | 0 |
| VESTINOL ® 9, Evonik | | | | | | | | | | |
| Oxeno GmbH | | | | | | | | | | |
| (Comparative Example) | | | | | | | | | | |

n.d. = Not determinable (e.g.: determination method used requires liquid phase at room temperature).

Unlike the current standard plasticizer diisononyl (ortho)phthalate, the terephthalic esters of the invention have markedly lower volatility (discernible from loss of mass after 10 minutes at 200° C.) for the same number of carbon atoms. When unbranched alcohol (n-nonanol; degree of branching=0) is used to produce the terephthalic esters, the product, as would be expected, is the unbranched terephthalate. At room temperature this is a solid, and conventional methods cannot use this to produce a plastisol that is processable and/or has good shelf life. Even when the degree of branching is high, about 3, as is obtained by way of example when 3,5,5-trimethylhexanol is used exclusively as alcohol component m for the esterification process with terephthalic acid, the terephthalate is solid at room temperature and cannot then be processed conventionally. If a mixture made of isononanol and 3,5,5-trimethylhexanol is used for producing the terephthalic esters (see Examples 1.6 and 1.7), the products obtained are solid or liquid at room temperature, and this varies with the average degree of branching. is The hardening process here generally involves a delay, i.e. does not begin immediately after or during the cooling procedure but only after several hours or several days. Esters which do not exhibit any melting signals when measured in DSC, and which exhibit a glass transition well below room temperature, are considered to have the best processability, since by way of example they can be stored in unheated outdoor tanks at any time of year anywhere in the world, and can be conveyed via pumps without difficulty. Esters which exhibit not only a glass transition but also one or more melting signals in the DSC thermogram, therefore exhibiting semicrystalline behaviour, cannot generally be processed under European winter conditions (i.e. at temperatures extending to −20° C.), because of premature solidification. According to the present results, the presence or absence of melting points depends primarily on the degree of branching of the ester groups. If the degree of branching is below 2.5 but above 1, the esters obtained have no melting signals in the DSC thermogram and exhibit ideal suitability for processing in plastisols.

### EXAMPLE 2

### Fundamental Suitability of Nonyl Terephthalates for Use in Compositions of the Invention: Production of Top Coat Plastisols

The intention below is first to demonstrate the fundamental suitability of nonyl terephthalates of different degrees of branching for use in the compositions of the invention, taking the example of a top coat formulation without additives. We intentionally begin here by omitting the use, as in the invention, of other plasticizers (which lower processing temperature), in order firstly to demonstrate to the effects of molecular branching and secondly to demonstrate performance with sole use of the terephthalic esters of the invention in comparison with the standard plasticizer diisononyl (ortho)phthalate (DINP).

TABLE 2
Constitution of PVC plastisols of Example
2. [All data in parts by mass]

| Plastisol formulation (Ex. 2) | 1** | 2* | 3* | 4** | 5* |
|---|---|---|---|---|---|
| Vestolit B 7021 -Ultra | 100 | 100 | 100 | 100 | 100 |
| VESTINOL ® 9 | 50 | | | | |
| Di(nonyl) terephthalate as in Ex. 1.1 | | 50 | | | |
| Di(nonyl) terephthalate as in Ex. 1.3 | | | 50 | | |
| Di(nonyl) terephthalate as in Ex. 1.6 | | | | 50 | |
| Di(nonyl) terephthalate as in Ex. 1.7 | | | | | 50 |
| Drapex 39 | 3 | 3 | 3 | 3 | 3 |
| Mark CZ 149 | 2 | 2 | 2 | 2 | 2 |

**= Comparative Example
*= Esters of the invention

The substances used are explained in more detail below:

Vestolit B 7021-Ultra: microsuspension PVC (homopolymer) with K value of 70 (determined to DIN EN ISO 1628-2); Vestolit GmbH & Co. KG.

VESTINOL® 9: diisononyl (ortho)phthalate (DINP), plasticizer; Evonik Oxeno GmbH.

Drapex 39: epoxidized soybean oil; costabilizer with plasticizing effect; Chemtura/Galata Chemicals.

Mark CZ 149: calcium/zinc stabilizer; Chemtura/Galata Chemicals.

The plastisol was produced using a Kreis VDKV30-3 dissolver (Niemann). The liquid constituents of the formulation were weighed in a mixing beaker prior to the solid constituents. The mixture was mixed manually with an ointment spatula until there was no remaining unwetted powder present. The mixing beaker was then clamped into the clamping apparatus of a dissolver mixer. The specimen was homogenized using the appropriate mixer disc (D: 50 mm). During the homogenization process, a vacuum pump was used to generate a vacuum in the mixing vessel. The pressure in the mixing container was monitored by a vacuum meter (DVR 2, Vakuubrand). The (abs.) pressure reached was below 10 mbar. The rotation rate was moreover increased from 330 rpm to 2000 rpm, and stirring was continued until the temperature on the digital display of the thermoindicator reached 30° C. This ensured that homogenization of the plastisol was achieved with defined energy input. The plastisol was then stirred and deaerated for a further 10 min at a rotation rate of 330 rpm. Once the plastisol had been produced, its temperature was immediately controlled to 25° C.

### EXAMPLE 3

### Determination of Viscosity of Top Coat Plastisols after 24 h of Storage Time (at 25° C.)

The viscosities of the plastisols produced in Example 2 were measured using a Physica MCR 101 (Paar-Physica) rheometer, in accordance with the procedure described in Analysis, point 10. Table (3) below shows the results by way of example for shear rates 100/s, 10/s, 1/s and 0.1/s.

TABLE 3
Shear viscosity of plastisols from Example
2 after 7 days of storage at 25° C.

| | Plastisol formulation as in Ex. 2 | | | | |
|---|---|---|---|---|---|
| | 1** | 2* | 3* | 4** | 5* |
| Shear viscosity at shear | 6.4 | 8.7 | 12.1 | n.d. | 13.7 |
| rate = 100/s [Pa*s] | | | | | |
| Shear viscosity at shear | 3.25 | 3.25 | 5 | n.d. | 6 |
| rate = 10/s [Pa*s] | | | | | |
| Shear viscosity at shear | 3.1 | 2.34 | 3 | n.d. | 3.2 |
| rate = 1/s [Pa*s] | | | | | |
| Shear viscosity at shear | 4.05 | 2.74 | 3.3 | n.d. | 3.4 |
| rate = 0.1/s [Pa*s] | | | | | |

**= Comparative Example
*= Esters of the invention
n.d. = not determinable

The plastisol of formulation 4 (degree of branching 2.78) crystallizes during storage and after 7 days is solid and no longer processable. Clearly discernible features in the case of the other specimens are the effect of shear rate and also the effect of degree of branching on plastisol viscosity. Specimens having relatively high degree of branching also generally give relatively high plastisol viscosity, and the viscosity difference here between low and high shear rate in principle increases with increasing degree of branching. The viscosity profile exhibited by the specimen with the lowest degree of branching is comparable with that of the DINP plastisol (=standard). As far as the processability of the plastisols is concerned it is therefore clear that as the degree of branching of the nonyl terephthalate used increases the amount of additional plasticizer needed in order to achieve the processing conditions for the DINP plastisol is likely to be greater.

The suitability limit for the purposes of the present invention is a degree of branching >2.5.

### EXAMPLE 4

### Determination of Plasticizing Effect or Plasticizer Efficiency on Castings via Determination of Shore Hardness (Shore A, Shore D)

Shore hardness is a measure of the softness of a test specimen. The further a standardized needle can penetrate into the test specimen during a certain test time, the lower the measured value. The plasticizer with the highest efficiency gives the lowest Shore hardness value for an identical amount of plasticizer. Since formulations are in practice often adjusted or optimized to give a particular Shore hardness, when highly efficient plasticizers are used it is possible to save a certain proportion of material in the formulation, thus reducing processor cost. For determination of Shore hardness values, the plastisols produced as in Example 2 were poured into round casting moulds made of brass with a diameter of 42 mm (ingoing weight: 20.0 g). The plastisols in the moulds were then gelled at 200° C. for 30 min in a convection oven, and removed after cooling, and, prior to the measurement, stored in an oven (25° C.) for at least 24 hours. The thickness of the discs was about 12 mm. The actual measurement was carried out as in Analysis point 13. The hardness determination results have been collated in Table 4.

TABLE 4
Shore A & D hardness on castings produced
from top coat plastisols (as in Example 2).

| | Plastisol formulation as in Ex. 2 | | | | |
|---|---|---|---|---|---|
| | 1** | 2* | 3* | 4** | 5* |
| Shore A | 80 | 86 | 91 | 92 | 90 |
| Shore D | 25 | 30 | 35 | 38 | 36 |

**= Comparative Example
*= Esters of the invention

Markedly reduced plasticizer efficiency is discernible for the terephthalic esters of the invention in the present formulation in comparison with DINP (=standard). Efficiency here is also markedly dependent on the degree of branching, and the most advantageous of the examples of the invention (2) exhibits a deviation of less than 10% in comparison with the DINP plastisol. As previously in Example 3 for plastisol viscosity, advantages are again exhibited here for the plasticizer efficiency of the terephthalic esters of the invention with low degree of branching. Hardness can therefore simply be controlled by way of the degree of branching of the terephthalic esters used in the invention, and another simple method available to the person skilled in the art is to achieve the hardness by way of an increase in the amount of plasticizer (“efficiency compensation”).

### EXAMPLE 5

### Production of (Top Coat) Foils from the Plastisols Produced in Example 2, and Determination of Opacity, Yellowness Index and Exudation Behaviour of Top Coat Foils

The foils were produced after an ageing time of 24 hours (at 25° C.). For production of the foils, a doctoring gap of 1.40 mm was set at the metering bar of a Mathis Labcoater (producer: W. Mathis AG). This gap was monitored by a feeler gauge and readjusted as necessary. The plastisols produced were doctored by means of the metering bar of the Mathis Labcoater onto a high-gloss paper (Ultracast Patent; Sappi Ltd.) clamped flat in a frame. The plastisol applied was then gelled at 200° C. for 2 min in the Mathis oven. Foil thickness was determined after cooling with the aid of a fast-action thickness gauge (KXL047; Mitutoyo) with accuracy of 0.01 mm. The thickness of the said foil was in all instances from 0.95 to 1.05 mm, when the stated doctoring gap was used. The thickness was measured at three different points on the foil.

Transparency is an essential criterion for assessing the quality of PVC top coats in the flooring sector, since ideal overall appearance can be achieved only with high transparency (=low opacity). The transparency of a PVC top coat foil is also a measure of the compatibility of the formulation constituents used to produce the foil, in particular being a measure for evaluating the compatibility of PVC matrix and plasticizer. High transparency (=low opacity) generally implies good compatibility. Opacity was determined as described in Analysis, point 14.

Yellowness index is another important quality criterion. Yellow colouring in the top coat can lead to considerable visual impairment of the decorative effect in a floor, and it is therefore generally possible to tolerate only very low yellowness index values in the PVC top coat. Yellow discoloration can be caused firstly by formulation constituents (and also by their by-products and degradation products), and secondly by (e.g. thermooxidative) degradation during the production process and/or during the use of the top coat or of the floor covering. Yellowness index was determined as described in Analysis, point 12.

Assessment of the exudation behaviour of the top coat foils can lead to conclusions about the permanence of the plasticizers used and of other formulation constituents in the gelled system. Severe migration of the formulation constituents (which can by way of example be apparent in the formation of oily films and/or droplets on the surface of the foil) has not only visual and aesthetic disadvantages but also numerous practical disadvantages. By way of example, the increased tack causes adhesion of dust and/or dirt, which in turn cannot be removed or cannot be removed entirely, therefore leading to disadvantageous appearance within a very short time. There is also severe impairment of surface feel, and an increased risk of slipping. Interactions with fixing adhesives can also cause uncontrolled separation of the floor covering. The grading system depicted in Table 5 is used to assess exudation behaviour. Exudation is generally what is known as a “knock-out” criterion, and the only useful grade in the evaluation is therefore a low grade. The foils are stored at 25° C. in the period between the evaluations.

TABLE 5
Evaluation system for evaluating exudation
behaviour of top coat foils.

| Evaluation | Definition |
|---|---|
| 1 | Very good (no diffusion or migration of any kind discernible; |
| | no film formation of any kind on the surface). |
| 3 | Good - satisfactory (no obvious diffusion or migration |
| | discernible; minimal film formation on the surface). |
| 5 | Defective (clear evidence of migration; “greasy” feel; |
| | droplet formation; haze due to exudation). |

Table 6 collates the results.

TABLE 6
Results for gelled top coat foils from Example 5.

| | Plastisol formulation (as in Ex. 2) | | | | |
|---|---|---|---|---|---|
| | 1** | 2* | 3* | 4** | 5* |
| Opacity [—] | 10.8 | 10.7 | 10.9 | n.d. | 11.2 |
| Yellowness index [—] | 8.9 | 9.1 | 9.4 | n.d. | 9.7 |
| Assessment of exudation | 1 | 1 | 1 | 5 | 1 |
| behaviour after 24 h | | | | | |
| Assessment of exudation | 1 | 3 | 3 | 5 | 3 |
| behaviour after 4 weeks | | | | | |

**= Comparative Example
*= Esters of the invention

With the exception of the (comparative) specimen which comprises terephthalic ester with a degree of branching of 2.78 (4), all of the other terephthalic esters (of the invention) exhibit transparency which is comparable with or very slightly inferior to that of the standard DINP, and a yellowness index which is comparable with or very slightly inferior to that of the standard DINP. In the case of specimen 4, a slight greasy film forms after as little as 24 h of storage time and prevents measurement. In respect of exudation behaviour, disadvantages are apparent when comparison is made with the standard DINP, because when the terephthalic esters of the invention are used as sole plasticizers compatibility of plasticizer and PVC is lower than with DINP.

It is clear that the degree of branching of the terephthalic esters has a significant effect on the properties of the plastisols and mouldings or foils produced therewith, but also that there is a clear restriction included here with regard to industrial applicability: because of the poor properties of the terephthalic esters listed as comparative example with a degree of branching of 2.78 they cannot be used per se. It is moreover clear that the sole use of the terephthalic esters of the invention as plasticizers leads to properties which are poorer than those of comparative DINP specimens.

### EXAMPLE 6

### Use of Nonyl Terephthalates Together with Other Plasticizers Which Reduce Processing Temperature in Unfilled Unpigmented PVC Plastisols

The advantages of the plastisols of the invention will be illustrated below by taking an unfilled, unpigmented PVC plastisol. The plastisols of the invention below here are examples inter alia of plastisols used for producing floor coverings. In particular, the plastisols of the invention below are examples of transparent outer layers (known as transparent top coats) which are used as upper layer in PVC floors of multilayer structure. The formulations shown here have been generalized, and the person skilled in the art can/must adapt them to the specific requirements applicable to processing and use in the respective application sector. In particular, we shall show that use of additional plasticizers (alongside the terephthalic esters of the invention) which reduce processing temperature can compensate for the disadvantages of the terephthalic esters (see Examples 2 to 5).

TABLE 7
Constitution of PVC plastisols of Example 6. [All data in parts by mass]

| Formulation: | 1** | 2** | 3* | 4* | 5* | 6* |
|---|---|---|---|---|---|---|
| Vestolit B 7021—Ultra | 100 | 100 | 100 | 100 | 100 | 100 |
| Vestinol 9 | 50 | | | | | |
| Di(nonyl) | | 50 | 40 | 40 | 40 | 40 |
| terephthalate as in Ex. 1.1 | | | | | | |
| Eastman DBT | | | 10 | | | |
| Vestinol INB | | | | 10 | | |
| Citrofol B II | | | | | 10 | |
| Santicizer 9201 | | | | | | 10 |
| Drapex 39 | 3 | 3 | 3 | 3 | 3 | 3 |
| Mark CZ 149 | 2 | 2 | 2 | 2 | 2 | 2 |

**= Comparative example
*= of the invention

An explanation is provided below of the substances used which are not found in the preceding examples:

Eastman DBT: di-n-butyl terephthalate; plasticizer; Eastman Chemical Co.

VESTINOL® INB: isononyl benzoate; plasticizer; Evonik Oxeno GmbH.

Citrofol B II: tributyl acetylcitrate; plasticizer; Jungbunzlauer AG.

Santicizer 9201: modified dibenzoate, plasticizer; Ferro Corp.

The plastisols were produced in accordance with the procedure described in Example 2 but with use of the formulations listed in Table 7.

### EXAMPLE 7

### Determination of Plastisol Viscosity for Top Coat Plastisols after Storage Time of 24 h and 7 days (at 25° C.)

The viscosities of the plastisols produced in Example 6 were measured using a Physica MCR 101 (Paar-Physica) rheometer, in accordance with the procedure described in Analysis, point 10. Table (8) below shows the results by way of example for shear rates 100/s, 10/s, 1/s and 0.1/s. In order to permit assessment of the shelf life of the plastisols, two measurements were made in each case (after to storage time of 24 h and 7 days at 25° C.).

TABLE 8
Shear viscosity of plastisols from Example 6 after storage
for 24 h and 7 days at 25° C.

| Plastisol formulation of | Storage | | | | | | | |
|---|---|---|---|---|---|---|---|---|
| Ex. 6 | time | | 1** | 2** | 3* | 4* | 5* | 6* |
| Shear viscosity at shear | 24 | h | 6 | 8.9 | 6 | 4.3 | 7.3 | 8.7 |
| rate = 100/s [Pa*s] | 7 | days | 6.5 | 8.5 | 6.2 | 4.2 | 7.4 | 9 |
| Shear viscosity at shear | 24 | h | 2.8 | 3.5 | 2.3 | 1.7 | 2.7 | 3.2 |
| rate = 10/s [Pa*s] | 7 | days | 3.2 | 3.2 | 2.4 | 1.7 | 2.8 | 3.3 |
| Shear viscosity at shear | 24 | h | 2.6 | 2.3 | 1.9 | 1.4 | 2.2 | 2.6 |
| rate = 1/s [Pa*s] | 7 | days | 3 | 2.3 | 2 | 1.5 | 2.3 | 2.8 |
| Shear viscosity at shear | 24 | h | 3.1 | 2.4 | 2.3 | 1.6 | 2.7 | 3.4 |
| rate = 0.1/s [Pa*s] | 7 | days | 3.8 | 2.6 | 2.5 | 1.8 | 2.8 | 3.8 |

**= Comparative example
*= of the invention

At high shear rates, the plastisol viscosity of the mixtures which comprise INB or DBT alongside DINT is (3) at the level of DINP (=standard) or markedly thereunder (6). The plastisols which comprise Citrofol B II or Santicizer 9201 alongside DINT are slightly above DINP level. The differences are less marked at low shear rates. All of the compositions of the invention exhibit excellent shelf life, i.e. exhibit only extremely small alterations of plastisol viscosity with increasing storage time.

Compositions are therefore provided which, when compared with DINP, which is the current standard, have better or similar processability with regard to coating speed, while also having excellent shelf life.

### EXAMPLE 8

### Determination of Gelling Behaviour of Top Coat Plastisols from Example 6

The gelling behaviour of the top coat plastisols produced in Example 6 was studied as described in Analysis, point 11 (see above), by using a Physica MCR 101 in oscillation mode after storage of the plastisols at 25° C. for 24 h. The results are shown in Table (9) below.

TABLE 9
Key points of gelling behaviour determined from the gelling curves
(viscosity curves) for the plastisols produced as in Example 6.

| Plastisol formulation as | | | | | | |
|---|---|---|---|---|---|---|
| in Ex. 6 | 1** | 2** | 3* | 4* | 5* | 6* |
| Plastisol viscosity | 87 | 121 | 97 | 107 | 99 | 95 |
| 1000 Pa*s reached at [° C.] | | | | | | |
| Plastisol viscosity | 102 | 137 | 122 | 127 | 125 | 120 |
| 10000 Pa*s reached at [° C.] | | | | | | |
| Maximum plastisol | 27700 | 16000 | 22200 | 15800 | 17200 | 21800 |
| viscosity [Pa*s] | | | | | | |
| Temperature at which | 137 | 147 | 139 | 134 | 142 | 142 |
| maximum plastisol | | | | | | |
| viscosity was reached [° C.] | | | | | | |

**= Comparative example
*= of the invention

When comparison is made with pure DINT, all of the additional plasticizers used lead to a significant reduction firstly of the temperature from which a significant rise in plastisol viscosity occurs as a consequence of onset of gelling (“plastisol viscosity 1000 Pa*s reached”) and secondly of the temperature at which maximum plastisol viscosity is reached, and they therefore lead to significantly reduced processing temperature. With regard to the temperature at which maximum plastisol viscosity is reached, the plastisols of the invention are at the level of the DINP plastisol (=standard) or thereunder. At the same time, the maximum plastisol viscosity achievable through the gelling process is sometimes markedly higher than with pure DINT, and this means that, at the same temperature, the gelling process is more complete when the additional plasticizers are used and leads to improved properties of the material in the final product. Compositions are therefore provided which, when comparison is made with use of DINT as sole plasticizer, lead to a significant reduction of processing temperature, while their processing properties are similar to those of standard DINP plastisol.

### EXAMPLE 9

### Determination of Plasticizing Effect or Plasticizer Efficiency on Castings by Determination of Shore Hardness (Shore A & Shore D)

The procedure described in Example 4 was used to produce the test specimens, but the plastisols produced in Example 6 were used. The procedure described in Analysis, point 13 was used to make the measurements. Table 10 collates the hardness determination results.

TABLE 10
Shore A and Shore D hardness determined on castings produced
from top coat plastisols (as in Example 6).

| Plastisol formulation as in Ex. 6 | 1** | 2** | 3* | 4* | 5* | 6* |
|---|---|---|---|---|---|---|
| Shore A | 80 | 89 | 83 | 83 | 84 | 86 |
| Shore D | 27 | 32 | 28 | 28 | 28 | 29 |

**= Comparative example
*= of the invention

When comparison is made with pure DINT, the additional plasticizers used reduce Shore hardness, i.e. increase plasticizer efficiency. In particular here, a level similar to that of DINP (=standard) is achieved for Shore D. Compositions are therefore provided which exhibit markedly increased plasticizer efficiency when comparison is made with sole use of DINT as plasticizer.

### EXAMPLE 10

### Determination of Opacity, Yellowness Index, Thermal Stability, Behaviour on Storage in Water and Exudation Behaviour of Top Coat Foils

The top coat foils were produced as described in Example 5, but the plastisols from Example 6 were used.

Opacity was determined as described in Analysis, point 14.

Yellowness index was determined as described in Analysis, point 12. In addition to yellowness index determined immediately after production of the top coat foil, yellowness index was determined again after storage of the foil at 200° C. for 10 minutes (in a Mathis oven), so that conclusions could be drawn concerning thermal stability.

The grading system depicted in Table 5 is used to assess exudation behaviour.

The foils are stored at 25° C. in the period between the evaluations.

The procedure described in Analysis, point 15 was used for the storage in water and to calculate water absorption and loss of mass due to storage in water. Table 11 collates the results of the studies.

TABLE 11
Results of studies on gelled top coat foils (plastisols from Example 6)

| Plastisol formulation as in | | | | | | |
|---|---|---|---|---|---|---|
| Ex. 6 | 1** | 2** | 3* | 4* | 5* | 6* |
| Opacity [-] | 10.4 | 10.7 | 10.8 | 11 | 10.5 | 11.3 |
| Yellowness index after | 9 | 9 | 9 | 9 | 8.8 | 9 |
| production [-] | | | | | | |
| Yellowness index after | 41 | 18 | 14 | 12 | 14 | 22.6 |
| 10 min. @ 200° C. | | | | | | |
| Assessment of exudation | 1 | 1 | 1 | 1 | 1 | 1 |
| behaviour after 24 h | | | | | | |
| Assessment of exudation | 1 | 3 | 1 | 3 | 1 | 1 |
| behaviour after 4 weeks | | | | | | |
| Water absorption after 7 days | +1.2 | +1.2 | +1.1 | +1.2 | +0.6 | −1.2 |
| of storage time @ 30° C. | | | | | | |
| [% by mass] | | | | | | |
| Loss of mass due to storage | +0.1 | +0.1 | −0.1 | 0 | −0.5 | −2.3 |
| in water at 30° C. for 7 days | | | | | | |
| [% by mass] | | | | | | |

**= Comparative example
*= of the invention

With regard to opacity, all of the foils are at a very good level comparable with that of the DINP specimen (1), and the same applies to yellowness index immediately after production of the top coat foils. However, after a residence time of 10 minutes at 200° C. some of the specimens which comprise the plasticizer mixtures of the invention exhibit markedly better (i.e. lower) yellowness indices, and are therefore markedly more thermally stable than DINP and also in some cases than DINT alone (2). Exudation behaviour is in all cases very good to good, and the use of the additional plasticizers in some cases brings about markedly improved compatibility, which in turn minimizes exudation. The storage in water clearly reveals the difference in hydrophilicity of the plasticizers used to reduce processing temperature. While the values for dibutyl terephthalate (3) and isononyl benzoate (4) do not deviate significantly from those known from the standard DINP (1), a marked loss of mass is discernible with the citric ester (5) and with the dibenzoate (6). In the last two instances, the person skilled in the art is aware of simple countermeasures, e.g. the use of surface sealing (e.g. based on polyurethane). Compositions are therefore provided which can be processed to give top coat foils and which are at the level of the standard DINP in terms of their opacity/transparency (while at the same time omitting ortho-phthalates). In terms of thermal stability, when comparison is made with the standard DINP, the results obtained by use of the compositions of the invention are markedly improved, and this leads to a significant reduction of formulation costs (through a reduction of stabilizer content). In terms of stability during storage in an aqueous medium, the result achievable depends on the additional plasticizers used.

### EXAMPLE 11

### Production of Filled and Pigmented Plastisols for Textile Coating (Production of Tarpaulins)

The advantages of the plastisols of the invention will be illustrated below by taking a filled, pigmented PVC plastisol. The plastisols of the invention below here are examples inter alia of plastisols used for producing tarpaulins (e.g. lorry tarpaulins). The formulations shown here have been generalized, and the person skilled in the art can/must adapt them to the specific requirements applicable to processing and use in the respective application sector.

TABLE 12
Constitution of filled and pigmented PVC plastisols
[all data in parts by mass].

| Formulation: | 1** | 2** | 3* | 4* | 5* | 6* | 7* | 8* |
|---|---|---|---|---|---|---|---|---|
| P 1430 K70 | 100 | 100 | 100 | 100 | 100 | 100 | 100 | 100 |
| Vestinol 9 | 65 | | | | | | | |
| Di(nonyl) | | 75 | 50 | 50 | 50 | 50 | 45 | 35 |
| terephthalate as in | | | | | | | | |
| Ex. 1.1 | | | | | | | | |
| Eastman DBT | | | 20 | | | | 20 | 30 |
| Santicizer 9201 | | | | 20 | | | | |
| Vestinol INB | | | | | 20 | | | |
| Citrofol B II | | | | | | 20 | | |
| Calcilit 6G | 15 | 15 | 15 | 15 | 15 | 15 | 15 | 15 |
| Kronos 2220 | 3 | 3 | 3 | 3 | 3 | 3 | 3 | 3 |
| Drapex 39 | 3 | 3 | 3 | 3 | 3 | 3 | 3 | 3 |
| Mark BZ 561 | 1.5 | 1.5 | 1.5 | 1.5 | 1.5 | 1.5 | 1.5 | 1.5 |

**= Comparative example
*= of the invention

An explanation is provided below of the substances used which are not found in the preceding examples:

P 1430 K 70: microsuspension PVC (homopolymer) with K value 70 (determined to DIN EN ISO 1628-2); Vestolit GmbH & Co. KG.

Calcilit 6G: calcium carbonate; filler; Alpha Calcit.

KRONOS 2220: Al- and Si-stabilized rutile pigment (TiO₂); white pigment; Kronos Worldwide Inc.

Mark BZ 561: barium/zinc stabilizer; Chemtura/Galata Chemicals.

### EXAMPLE 12

### Determination of Plastisol Viscosity for Filled and Pigmented Plastisols after Storage Time of 24 h and 7 days (at 25° C.)

The viscosities of the plastisols produced in Example 11 were measured using a Physica MCR 101 (Paar-Physica) rheometer, in accordance with the procedure described in Analysis, point 10. Table (13) below shows the results by way of example for shear rates 100/s, 10/s, 1/s and 0.1/s. In order to permit assessment of the shelf life of the plastisols, two measurements were made in each case (after storage time of 24 h and 7 days).

TABLE 13
Shear viscosity of plastisols from Example 11 after storage
for 24 h and 7 days at 25° C.

| Plastisol formulation | Storage | | | | | | | | |
|---|---|---|---|---|---|---|---|---|---|
| as in Ex. 11 | time | 1** | 2** | 3* | 4* | 5* | 6* | 7* | 8* |
| Shear viscosity at | 24 h | 2.8 | 3.4 | 1.6 | 2.3 | 1 | 2.1 | 2 | 1.7 |
| shear rate = 100/s | 7 days | 2.9 | 2.7 | 1.6 | 2.5 | 1 | 2 | 2.2 | 2 |
| [Pa*s] | | | | | | | | | |
| Shear viscosity at | 24 h | 2.1 | 1.7 | 1.2 | 1.6 | 0.85 | 1.5 | 1.5 | 1.4 |
| shear rate = 10/s | 7 days | 2.4 | 1.7 | 1.4 | 1.8 | 0.95 | 1.6 | 1.7 | 1.7 |
| [Pa*s] | | | | | | | | | |
| Shear viscosity at | 24 h | 2.6 | 1.7 | 1.6 | 1.9 | 1.2 | 1.8 | 1.9 | 1.8 |
| shear rate = 1/s | 7 days | 3.1 | 2 | 1.9 | 2.2 | 1.4 | 2.2 | 2.3 | 2.3 |
| [Pa*s] | | | | | | | | | |
| Shear viscosity at | 24 h | 4.7 | 2.9 | 3 | 3.2 | 2.4 | 3.4 | 3.9 | 3.8 |
| shear rate = 0.1/s | 7 days | 5.8 | 3.6 | 3.7 | 4.1 | 3 | 4.3 | 4.8 | 4.8 |
| [Pa*s] | | | | | | | | | |

**= Comparative example
*= of the invention

After 24 h of storage time, across the entire range of shear rates considered, all of the compositions of the invention exhibit a plastisol viscosity that is lower not only than that of the DINP plastisol (=standard) but also than that of the comparable plastisol using pure DINT. They are therefore suitable for markedly higher processing speed, in particular in spreading processes. An additional factor is that because they have lower viscosity they are capable of markedly better penetration into the textiles or laid scrims used to produce the tarpaulins, and therefore lead to stronger composites. In view of the sometimes markedly lower plastisol viscosity, it is also possible to reduce the amount of plasticizer markedly, without losing these two advantages. All of the compositions of the invention exhibit excellent shelf life, i.e. exhibit only extremely small alterations of plastisol viscosity. Compositions are therefore provided which, because of their low plastisol viscosity, permit faster processing, and at the same time lead to markedly improved products (tarpaulins), while at the same time also exhibiting markedly reduced total plasticizer requirement, and also excellent shelf life.

### EXAMPLE 13

### Determination of Gelling Behaviour of Filled and Pigmented Plastisols from Example 11

The gelling behaviour of the plastisols produced in Example 11 was studied as described in Analysis, point 10 (see above), by using a Physica MCR 101 in oscillation mode after storage of the plastisols at 25° C. for 24 h. The results are shown in Table (14) below.

TABLE 14
Key points of gelling behaviour determined from the gelling curves
(viscosity curves) for the filled and pigmented plastisols produced as in
Example 11.

| Plastisol formulation | | | | | | | | |
|---|---|---|---|---|---|---|---|---|
| as in Ex. 11 | 1** | 2** | 3* | 4* | 5* | 6* | 7* | 8* |
| Plastisol viscosity | 93 | 134 | 112 | 107 | 120 | 115 | 101 | 82 |
| 1000 Pa*s reached at | | | | | | | | |
| [° C.] | | | | | | | | |
| Plastisol viscosity | 125 | — | 134 | 132 | — | 136 | 130 | 120 |
| 10000 Pa*s reached at | | | | | | | | |
| [° C.] | | | | | | | | |
| Maximum plastisol | 17300 | 6800 | 11200 | 11700 | 9800 | 11400 | 13200 | 16000 |
| viscosity | | | | | | | | |
| [Pa*s] | | | | | | | | |
| Temperature at which | 140 | 151 | 139 | 138 | 144 | 142 | 139 | 132 |
| maximum plastisol | | | | | | | | |
| viscosity was reached | | | | | | | | |
| [° C.] | | | | | | | | |

**= Comparative example
*= of the invention

When the compositions of the invention are compared with pure DINT they exhibit advantages in processing temperature, and this also applies on at least some occasions when they are compared with pure DINP. Gelling behaviour can be adjusted as required as a function of additional plasticizer used and of the quantitative proportion with respect to DINT. The same applies to the maximum plastisol viscosity achievable through the gelling procedure.

Compositions are therefore provided which permit markedly faster processing and/or permit processing at lower processing temperatures, while the properties of the materials that they give are similar to or better than those provided by the known standard plastisols.

### EXAMPLE 14

### Determination of Plasticizing Effect or Plasticizer Efficiency on Castings via Determination of Shore Hardness (Shore A & Shore D)

The procedure described in Example 4 was used to produce the test specimens, but the plastisols produced in Example 11 were used. The procedure described in Analysis, point 13 was used to make the measurements. Table 15 collates the hardness determination results.

TABLE 15
Shore A and Shore D hardness determined on castings produced
from plastisols (from Example 11).

| Plastisol formulation as in Ex. 11 | 1 | 2 | 3 | 4 | 5 | 6 | 7 | 8 |
|---|---|---|---|---|---|---|---|---|
| Shore A | 72 | 71 | 67 | 72 | 70 | 70 | 72 | 69 |
| Shore D | 19 | 18 | 17 | 18 | 17 | 17 | 18 | 17 |

When comparison is made with sole use of DINP (1) or DINT (2) as plasticizer, some of the compositions of the invention exhibit considerably improved is plasticizer efficiency. This can reduce the total amount of plasticizer and can therefore markedly reduce formulation costs.

1. A composition, comprising:
a polymer; and
diisononyl terephthalate as a plasticizer; and
an additional plasticizer,
wherein the polymer is at least one polymer selected from the group consisting of polyvinyl chloride, polvvinylidene chloride, polyvinyl butyrate, polyalkyl (meth)acrylate, and a copolymer thereof, an average degree of branching of an isononyl group of a diisononyl terephthalate ester is from 1.15 to 2.5, and additional plasticizer reduces a processing temperature.

2. The composition according to claim 1, wherein the polymer is polyvinyl chloride.

3. The composition according to claim 1, wherein the polymer is a copolymer of vinyl chloride having at least one monomer selected from the group consisting of vinylidene chloride, vinyl butyrate, methyl (meth)acrylate, ethyl (meth)acrylate, and butyl (meth)acrylate.

4. The composition according to claim 1, wherein the composition comprises the diisononyl terephthalate in an amount of from 5 to 90% by mass per 100 parts by mass of the polymer.

5. The composition according to claim 1,
wherein the additional plasticizer is not diisononyl Terephthalate.

6. The composition according to claim 1,
wherein the additional plasticizer is at least one plasticizer selected from the group consisting of a dialkyl phthalate, a trialkyl trimellite, a dialkyl adipate, a dialkyl terephthalate, a dialkyl cyclohexanedicarboxylate, a benzoic ester, a glycol ester, an alkylsulphonic ester, a glycerol ester, an isosorbide ester, a citric ester, an alkylpyrrolidone, and an epoxidized oil.

7. The composition according to claim 6, wherein a ratio by mass of the additional plasticizer to the diisononyl terephthalate is from 1:20 to 2:1.

8. The composition according to claim 1, further comprising:
a PVC suspension, a PVC microsuspension, a PVC emulsion, or a combination thereof.

9. The composition according to claim 1, further comprising:
an additive,
wherein the additive is at least one additive selected from the group consisting of a filler, a pigment, a matting agent, a heat stabilizer, an antioxidant, a UV stabilizer, a flame retardant, a viscosity regulator, a solvent, a deaerating agent, an adhesion promoter, a process aid, and a lubricant.

10. A method for producing a floor covering, a wall paper or any other wall covering, a tarpaulin or a coated textile, the method comprising:
applying the composition according to claim 1.

11. A moulding, comprising:
the composition according to claim 1.

12. A floor covering, comprising:
the composition according to claim 1.

13. A wallpaper, comprising:
the composition according to claim 1.

14. A tarpaulin, comprising:
the composition according to claim 1.

15. A coated textile, comprising:
the composition according to claim 1.

16. A wall covering, comprising:
the composition according to claim 1.
